(19) United States
(12) Patent Application Publication
(10) Pub. No.: US 2013/0313380 A1
(43) Pub. Date: Nov. 28, 2013

(54) ANTENNA DEVICE FOR ELECTROMAGNETIC MEASUREMENT

(71) Applicants: YONG-SHENG YANG, Shenzhen City (CN); XIAO-LIAN HE, Shenzhen City (CN)

(72) Inventors: YONG-SHENG YANG, Shenzhen City (CN); XIAO-LIAN HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/525,387

(22) Filed: Jun. 18, 2012

(30) Foreign Application Priority Data
May 28, 2012 (CN) 201210168278.0

(51) Int. Cl. H01Q 1/12

(52) U.S. Cl. 248/123.2

(57) ABSTRACT

An antenna device includes a base, an adjusting pole, an installing apparatus, a supporting pole, an antenna installed to a first end of the supporting pole, and a balance apparatus installed to a second end of the supporting pole. The installing apparatus defines an installing hole along the horizontal direction. A first pressure sensor and a second pressure sensor are respectively installed in two opposite ends of the installing hole. The supporting pole is slidably received in the installing hole to abut against both of the first and second pressure sensors. The balance apparatus includes a controller electrically connected to the first and second pressure sensors and a motor. The controller controls the rotation direction of the motor according to pressures applied on the first sensor and the second pressure sensor, so that the balance apparatus moves along the supporting pole, until the pressures are the same.

### CROSS-REFERENCE OF RELATED APPLICATION

Relevant subject matter is disclosed in a pending U.S. patent application, titled “ANTENNA DEVICE for electromagnetic measurement”, with the application Ser. No. 13/491,582, filed on Jun. 7, 2012, which is assigned to the same assignee as this patent application.

### BACKGROUND

1. Technical Field

The present disclosure relates to an antenna device for electromagnetic measurement.

2. Description of Related Art

In electromagnetic measurement, such as electromagnetic interference (EMI) measurement, a test antenna is installed to a supporting pole, and a combination of the test antenna and the supporting pole is horizontally fixed in an antenna holding device for measuring various kinds of information technology equipments (ITEs), such as personal computers, liquid crystal displays, or mobile phones. However, the weight of the test antenna is heavy, an end of the supporting pole with test antenna installing is pressed down, so the test antenna cannot horizontally align with the ITE.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, partially cutaway, and isometric view of an exemplary embodiment of an antenna device.

FIG. 2 is an enlarged view of the circled portion II of FIG. 1.

FIG. 3 is an assembled, isometric view of the antenna device of FIG. 1.

FIG. 4 is an enlarged view of the circled portion IV of FIG. 3.

FIG. 5 is similar to FIG. 3, but showing the antenna device in use.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

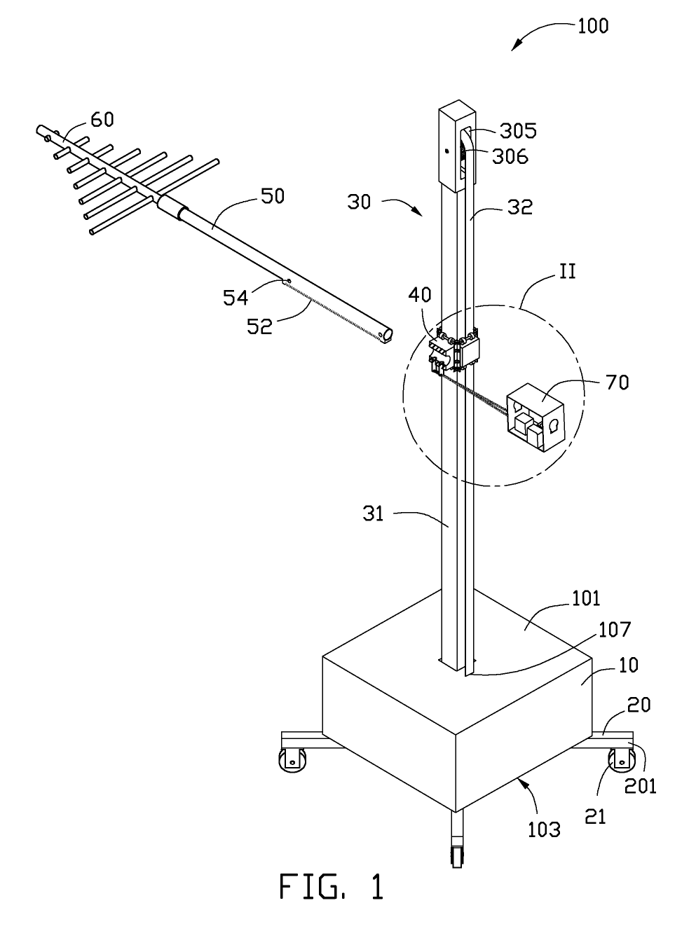

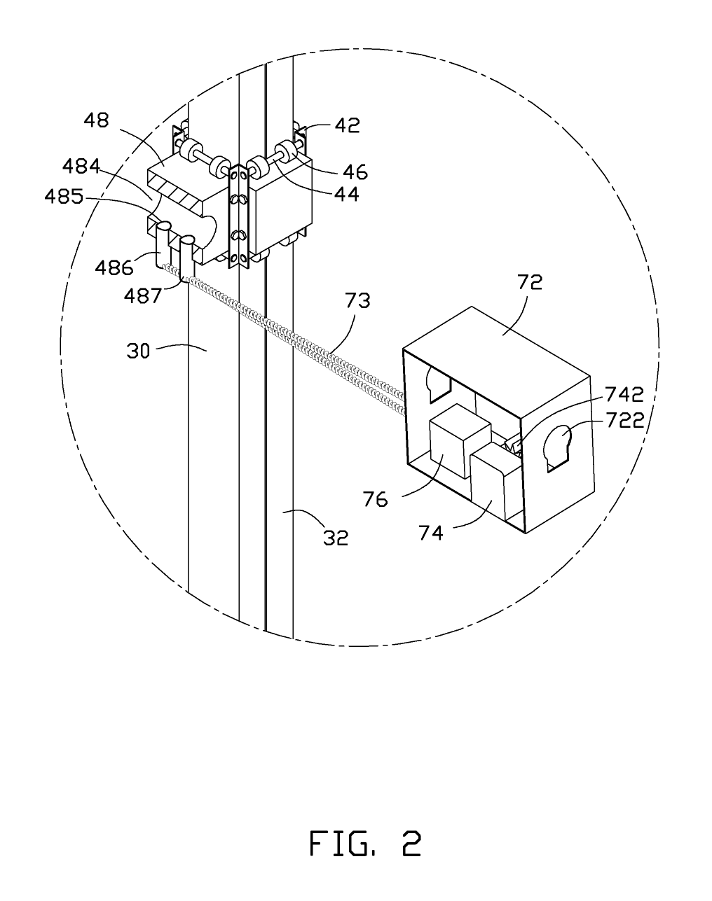

FIGS. 1 and 2, show an exemplary embodiment of an antenna device 100 which can be used to measure the intensity of electromagnetic radiations generated by an information technology equipment (ITE), such as a personal computer, a liquid crystal display, or a mobile telephone. The antenna device 100 includes a base 10, a holder 20, an adjusting pole 30, an installing apparatus 40, a supporting pole 50, an antenna 60, and a balance apparatus 70.

The base 10 is substantially rectangular, and includes a bottom surface 103 and a top surface 101. The holder 20 is substantially cross-shaped and mounted under the base 10. The holder 20 includes four beams 201 converged together, and four conveying wheels 21 are respectively mounted on the undersides of the beams 201. In the embodiment, each beam 201 has one conveying wheel 21 mounted on the underside of the beam 201. The four conveying wheels 21 are rotatably mounted on four distal ends of the beams 201. Thus the holder 20 and the base 10 can be horizontally moved due to rotation of the conveying wheels 21.

The adjusting pole 30 includes a pole body with a rectangular cross-section 31 and a transmission belt 32. A bottom end of the pole body 31 is perpendicularly fixed to the base 10 and extends through a center of the top surface 101. A longitudinal through hole 305 is defined in a top end of the pole body 31, extending through opposite sides of the pole body 31. An adjusting wheel 306 is rotatably mounted in the through hole 305. The transmission belt 32 is coiled on the adjusting wheel 306 and is pulled to extend longitudinally along the pole body 31 by a motor (not shown) installed in the base 10. A rotation of the adjusting wheel 306 can drive the transmission belt 32 to move along the pole body 31.

The installing apparatus 40 slidably fits about the adjusting pole 30 in a longitudinal manner, and includes four angle irons 42 respectively at four corners of the pole body 31 of the adjusting pole 30. A rectangular positioning block 48 is sandwiched between every two adjacent angle irons 42. A top and a bottom of every two adjacent angle irons 42 each are installed with a shaft 44. Two rollers 46 are slidably fit about each shaft 44. A part of the transmission belt 32 is fixedly extended through one of the positioning blocks 48. In this way, movements of the transmission belt 32 along the pole body 31 can drive the installing apparatus 40 to slide along the pole body 31. Another positioning block 48 defines an installing hole 484 along the horizontal direction for receiving the supporting pole 50, and two opposite ends of a bottom of the positioning block 48 define two receiving holes 485 communicating with the installing hole 484. A first pressure sensor 486 and a second pressure sensor 487 are respectively received in the receiving holes 485, arranged along a lengthwise direction of the receiving hole 485.

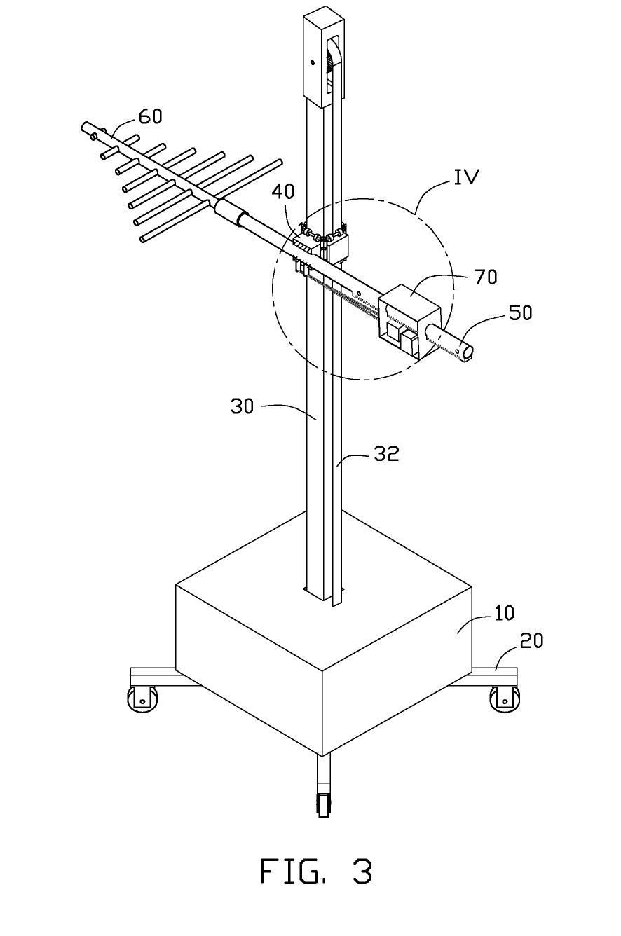

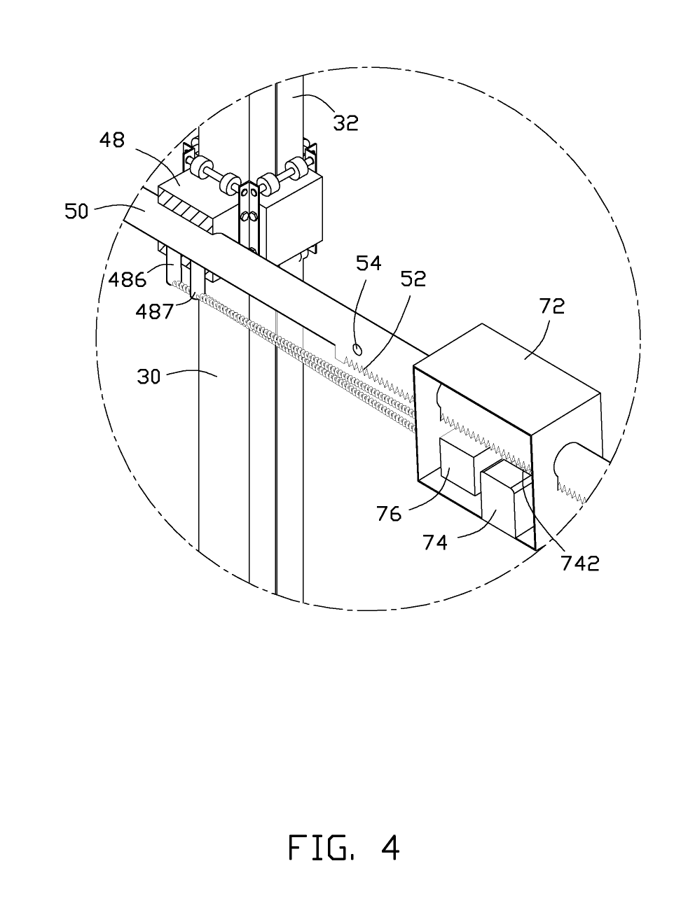

FIGS. 3 and 4, the supporting pole 50 includes a rack 52 defined in an outside surface of a first end of the supporting pole 50. Two infrared sensors 54 are installed on two opposite ends of the rack 52. A second end of the supporting pole 50 is inserted into the installing hole 484 of the installing apparatus 40, and the supporting pole 50 abuts against both of the first pressure sensor 486 and the second pressure sensor 487. The antenna 60 is mounted to the second end of the supporting pole 50. The first sensor 486 is located between the antenna 60 and the second sensor 487.

The balance apparatus 70 includes a rectangular casing 72, a motor 74 installed in the casing 72, a controller 76 installed in the casing 72, and two cables 73 each connected between the controller 76 and a corresponding one of the first and second pressure sensors 486 and 487. Two opposite ends of the casing 72 each define a guiding hole 722 for allowing the first end of the supporting pole 50 to slidably extend through. The motor 74 includes a gear wheel 742 located between and below the guiding holes 722, to mesh with the rack 52 of the supporting pole 50. The controller 76 controls the rotation direction of the gear wheel 742 according to the respective pressures applied on the first and second pressure sensors 486 and 487 by the supporting pole 50, so that the balance apparatus 70 moves along the supporting pole 50 relative to the antenna 60, until the pressure applied to the first pressure sensor 486 by the supporting pole 50 is equal to the pressure applied to the second pressure sensor 487 by the supporting pole 50. The balance apparatus 70 can be moved between the infrared sensors 54 of the supporting pole 50. A combination of the installing apparatus 40, the supporting pole 50, the antenna 60, and the balance apparatus 70 can be moved along the adjusting pole 30 by the transmission belt 32 and the installing apparatus 40.

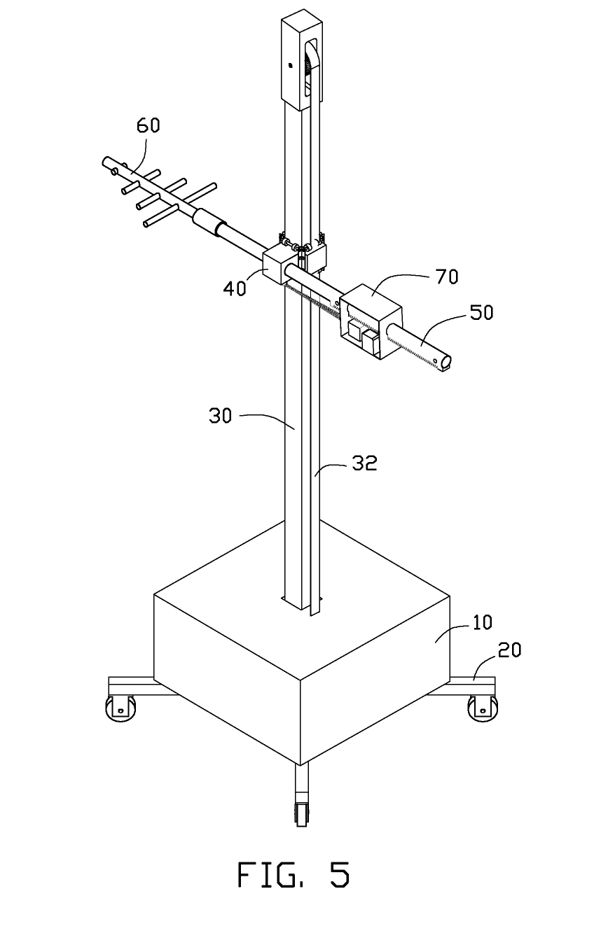

FIG. 5, in use, if the pressure applied on the first pressure sensor 486 by the supporting pole 50 is greater than the pressure applied on the second pressure sensor 487 by the supporting pole 50, the controller 76 controls the gear wheel 742 to rotate, the balance apparatus 70 moves along the supporting pole 50 away from the adjusting pole 30, until the pressure applied on the first pressure sensor 486 is equal to that the pressure applied on the second pressure sensor 487. The motor 74 stops working, at this time, the antenna 60 horizontally aligns with an information technology equipment (ITE) to measure electromagnetic radials of the ITE. If the pressure applied on the first pressure sensor 486 by the supporting pole 50 is less than the pressure applied on the second pressure sensor 487 by the supporting pole 50, the controller 76 controls the gear wheel 742 to rotate reversely, to move the balance apparatus 70 toward the adjusting pole 30, until the pressure applied on the first pressure sensor 486 is equal to the pressure applied on the second pressure sensor 487.

When disengaging the antenna 60, the pressure applied on the first pressure sensor 486 by the supporting pole 50 is less than the pressure applied on the second sensor 487 by the supporting pole 50, the controller 76 controls the gear wheel 742 to rotate reversely, the balance apparatus 70 moves toward the adjusting pole 30, to prevent the rest antenna device 100 from collapsing.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An antenna device, comprising:
a base;
an adjusting pole extending up from the base;
an installing apparatus slidably installed to the adjusting pole along a lengthwise direction of the adjusting pole, and defining an installing hole extending along a horizontal direction, a first pressure sensor and a second pressure sensor respectively installed in two opposite ends of a bottom wall bounding the installing hole;
a supporting pole forming a rack and inserted into the installing hole to abut against both of the first and second pressure sensors;
an antenna installed to a first end of the supporting pole; and
a balance apparatus slidably mounted to a second end of the supporting pole opposite to the antenna;
wherein the rack is formed on the second end of the supporting pole, the balance apparatus comprises a controller electrically connected to the first and second pressure sensors, and a motor with a gear wheel meshing with the rack of the supporting pole, the controller controls the rotation direction of the gear wheel according to pressures applied on the first pressure sensor and the second pressure sensor by the supporting pole, so that the balance apparatus moves along the supporting pole relative to the adjusting pole, until the pressure applied on the first pressure sensor by the supporting pole is equal to the pressure applied on the second pressure sensor by the supporting pole.

2. The antenna device of claim 1, wherein the first pressure sensor is located between the antenna and the second pressure sensor, the balance apparatus is located at a side of the second pressure sensor opposite to the first pressure sensor.

3. The antenna device of claim 1, wherein the installing apparatus comprises a positioning block, the installing hole is horizontally defined in the positioning block and extends through two opposite ends of the positioning block, two opposite ends of a bottom of the positioning block define two receiving hole communicating with the installing hole, the first and second sensors are respectively received in the receiving holes.

4. The antenna device of claim 3, wherein the adjusting pole comprises a pole body and a transmission belt, a bottom end of the pole body is fixed to the base, a longitudinal through hole is defined in a top end of the pole body, an adjusting wheel is rotatably received in the through hole, the transmission belt is coiled on the adjusting wheel and is pulled to extend longitudinally along the pole body, the installing apparatus is slidably fitted about the pole body and fixed to the transmission belt.

5. The antenna device of claim 4, wherein the pole body is substantially rectangular in cross-section, the installing apparatus further comprises four angle irons at four corners of the pole body, one positioning block is sandwiched between every two adjacent angle irons, tops and bottoms of every two adjacent angle irons is installed with two shafts, at least one rollers 46 is rotatably mounted to each shaft.

6. The antenna device of claim 1, wherein the balance apparatus further comprises a rectangular casing, the motor and the controller are installed in the casing, two opposite ends of the casing each define a guiding hole for allowing the second end of the supporting pole to slidably extend through.

7. The antenna device of claim 6, wherein two infrared sensors are installed on two opposite ends of the rack, the balance apparatus is slidable between the infrared sensors, the balance apparatus is operable to be slid along the supporting pole by the controller, until one of the infrared sensors moves to a corresponding end of the casing.

8. The antenna device of claim 1, wherein a cross-shaped holder is mounted under the base, the holder comprises four beams converged together, and four conveying wheels respectively mounted on undersides of the beams.

9. The antenna device of claim 1, wherein the antenna is detachably installed to the first end of the supporting pole.
